(19) United States
(12) Patent Application Publication
(10) Pub. No.: US 2025/0148397 A1
(43) Pub. Date: May 8, 2025

(54) AUTOMATED CRISIS SIMULATION FOR BUSINESS CONTINUITY PLANNING (BCP)

(71) Applicant: Rakuten Symphony, Inc., Tokyo (JP)

(72) Inventor: Srikrishna Chennampalli Nagaraja RAO, Tokyo (JP)

(21) Appl. No.: 18/564,613

(22) PCT Filed: Nov. 2, 2023
(86) PCT No.: PCT/US2023/036674

§ 371 Date: Nov. 28, 2023

(51) Int. Cl. G06Q 10/0637; G06Q 10/067; H04W 24/06

(52) U.S. Cl. CPC G06Q 10/06375; G06Q 10/067; H04W 24/06

(57) ABSTRACT

An automated crisis simulator and method for providing automated crisis simulation for Business Continuity Planning (BCP). Data is entered in a crisis simulation User Interface (UI) to define a crisis simulation. A crisis notification is received and a determination is made whether the notification of the crisis is a fake crisis notification. In response to the notification being determined to be a real crisis notification, a manager of the mobile network is notified of the crisis being real and the crisis simulation is terminated. Alternatively, in response to the notification being determined to be the fake crisis notification associated with the crisis simulation, the manager of the mobile network is notified, wherein a drill is initiated according to a predetermined protocol to address the crisis simulation. A drill report is recorded, which enables the response of the operations and monitoring teams to be analyzed to identify areas for improvement.

### TECHNICAL FIELD

This description relates to an automated crisis simulator for Business Continuity Planning (BCP), and a method for providing automated crisis simulation.

### BACKGROUND

Network telecommunications is a core infrastructure, just like roads, railways, and air transportation. Thus, network telecommunications is of high importance to consumers and to governments. However, mobile networks are subject to natural disasters and other crisis events. A crisis includes events and issues that are able to impact the mobile network, such as political or civil unrest.

Disturbance and crisis scenarios prevent the utilization of mobile networks. Disaster and crisis scenarios usually occur without a warning due to different conditions such as natural weather-based storms or disasters caused by humans, such as accidents or sabotage. The effects of a crisis event are devastating and usually prevent the utilization of mobile networks.

Typically, storms are the cause of blackouts in electrical grids. In addition, disruption to mobile networks has an impact on public safety, thus resulting in service and communication outages in urban and rural areas. Power outages prevent citizens from requesting emergency help in these outage areas. In addition, maintenance and rescue teams are not able to communicate through commercial mobile networks and therefore have to rely on a separate communication system.

There are comprehensive business continuity management policies adopted by mobile network operators. Mobile network operators include a Business Continuity Planning (BCP) department that handles readiness of the mobile networks. However, simulating a crisis event to test preparedness in the mobile network is difficult. Direct simulation of mobile networks takes hours to simulate directly using a realistic model. Further, the performance of the mobile network and a team's response to a crisis is difficult to evaluate.

### SUMMARY

In at least one embodiment, a method for providing automated crisis simulation for Business Continuity Planning (BCP) includes entering data in a crisis simulation User Interface (UI) to define a crisis simulation. A notification of a crisis associated with a mobile network is received. A determination is made whether the notification of the crisis is a fake crisis notification associated with the crisis simulation. In response to the notification being determined to be a real crisis notification, a manager of the mobile network is notified of a real crisis and the crisis simulation is terminated, or in response to the notification being determined to be the fake crisis notification associated with the crisis simulation, the manager of the mobile network is notified to initiate a drill according to a predetermined protocol to address the crisis simulation. The drill is initiated according to the predetermined protocol to address the crisis simulation.

In at least one embodiment, a crisis simulator includes a user interface (UI) for presenting a crisis notification associated with a mobile network. A communications interface is provided for accessing network information to determine whether the crisis notification is a fake crisis notification associated with a crisis simulation. The UI receives crisis validity information based on the network information accessed via the communication interface indicating whether the crisis notification is a fake crisis notification associated with the crisis simulation. In response to the receiving the crisis validity information indicating the crisis notification is a real crisis notification, providing an alert to a manager of the mobile network that the crisis notification is associated with a real crisis and presenting a crisis response for addressing the real crisis. Alternatively, in response to the receiving the crisis validity information indicating the crisis notification is associated with the crisis simulation, providing an alert to the manager of the mobile network that the crisis notification is associated with the crisis simulation and to initiate a drill according to a predetermined protocol to address the crisis simulation.

In at least one embodiment, a non-transitory computer-readable media having computer-readable instructions stored thereon, which when executed by a processor causes the processor to perform operations including entering data in a crisis simulation User Interface (UI) to define a crisis simulation. A notification of a crisis associated with a mobile network is received. A determination is made whether the notification of the crisis is a fake crisis notification associated with the crisis simulation. In response to the notification being determined to be a real crisis notification, a manager of the mobile network is notified of a real crisis and the crisis simulation is terminated, or in response to the notification being determined to be the fake crisis notification associated with the crisis simulation, the manager of the mobile network is notified to initiate a drill according to a predetermined protocol to address the crisis simulation. The drill is initiated according to the predetermined protocol to address the crisis simulation.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates a disaggregated Radio Access Network (RAN) architecture according to at least one embodiment.

FIG. 2 is a User Interface (UI) for defining a crisis according to at least one embodiment.

FIG. 3 is a UI for selecting the geography and time of the crisis according to at least one embodiment.

FIG. 4 is a UI for selecting the impact on business for the crisis simulation according to at least one embodiment.

FIG. 5 is a Confirmation UI according to at least one embodiment.

FIG. 6 is a flowchart of a method for automatic simulating a crisis for Business Continuity Planning (BCP) according to at least one embodiment.

FIG. 7 is a flow chart of the Simulation Flow according to at least one embodiment.

FIG. 8 shows a block diagram of the crisis simulator according to at least one embodiment.

FIG. 9 is a high-level functional block diagram of a processor-based system according to at least one embodiment.

### DETAILED DESCRIPTION

Embodiments described herein describe examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above.” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, data-streaming or signaling-streaming. The foregoing terms are utilized interchangeably in the subject specification and related drawings. The terms “access point.” “base station.” “Node B.” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, data-streaming or signaling-streaming from UE.

In at least one embodiment, a method for providing automated crisis simulation for Business Continuity Planning (BCP) includes entering data in a crisis simulation User Interface (UI) to define a crisis simulation, receiving a notification of a crisis associated with a mobile network, determining whether the notification of the crisis is a fake crisis notification associated with the crisis simulation, and in response to the notification being determined to be a real crisis notification, notifying a manager of the mobile network of a real crisis and ending the crisis simulation, or in response to the notification being determined to be the fake crisis notification associated with the crisis simulation, notifying the manager of the mobile network to initiate a drill according to a predetermined protocol to address the crisis simulation, and initiating the drill according to the predetermined protocol to address the crisis simulation.

Embodiments described herein provide a method that provides one or more advantages. For example, to improve the preparedness of operations and monitoring teams, a simulated crisis in a mobile network is defined and initiated. The simulated crisis imitates the external risks to the mobile network, including (but not limited to) natural disasters, civil unrests or external threats can have a huge impact on the business. Drills are able to be regularly performed to determine the preparedness of the operations and monitoring teams, wherein the drills are based on a set of protocols specified by factors such as a Type of Business, Local Laws & Regulations, Company Policy on BCP and Compliance, and the like. A drill report is recorded, which enables the response of the operations and monitoring teams to be analyzed to identify areas for improvement.

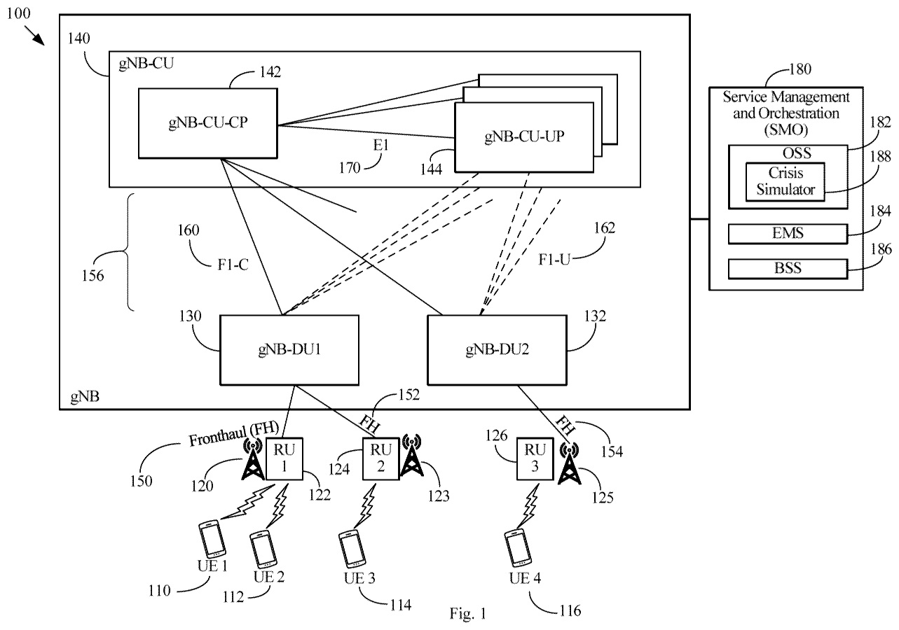

FIG. 1 illustrates a disaggregated Radio Access Network (RAN) architecture 100 according to at least one embodiment.

In FIG. 1, UE 1 (User Equipment 1) 110, UE 2 112, UE 3 114, UE 4 116 access a mobile network via RAN 100. RAN100 includes Radio Towers 120, 123, 125. Radio Towers 120, 123, 125 are associated with RU (Radio Unit) 1 122, RU 2 124, RU 3 126, respectively.

RU 1 122, RU 2 124, RU 3 126 handle the Digital Front End (DFE) and the parts of the PHY layer, as well as the digital beamforming functionality. RU 1 122 and RU 2 124 are associated with gNB-Distributed Unit (gNB-DU) 1 130, and RU 3 126 is associated with gNB-DU2 132. gNB-DU1 130 and gNB-DU2 132 are responsible for real time Layer 1 and Layer 2 scheduling functions. For example, in 5G, Layer-1 is the Physical Layer, Layer-2 includes the Media Access Control (MAC), Radio link control (RLC), and Packet Data Convergence Protocol (PDCP) layers, and Layer-3 (Network Layer) is the Radio Resource Control (RRC) layer. Layer 2 is the data link or protocol layer that defines how data packets are encoded and decoded, and how data is to be transferred between adjacent network nodes. Layer 3 is the network routing layer and defines how data moves across the physical network.

gNB-DU1 130 is coupled to the RU 1 122 via Fronthaul connection 150, and to RU 2 124 via Fronthaul connection 152. gNB-DU2 132 is coupled to RU 3 126 via Fronthaul connection 154. gNB-DU1 130 and gNB-DU2 132 run the Radio Link Control (RLC), MAC, and parts of the Physical (PHY) layer. gNB-DU1 130 and gNB-DU2 132 include a subset of the eNB/gNB functions, depending on the functional split option, and operation of gNB-DU1 130 and gNB-DU2 132 are controlled by Centralized Unit (CU) 140. gNB-CU 140 is responsible for non-real time, higher L2 and L3. Server and relevant software for gNB-CU 140 is able to be hosted at a site or is able to be hosted in an edge cloud (datacenter or central office) depending on transport availability and the interface for the Fronthaul connections 150, 152, 154. The server and relevant software of gNB-CU 140 is also able to be co-located at gNB-DU1 130 or gNB-DU2 132, or is able to be hosted in a regional cloud data center.

The gNB-CU 140 handles the RRC and PDCP layers. gNB-CU 140 includes a gNB-CU-Control Plane (CU-CP) 142 and one or more gNB-CU-User Planes (CU-UP) 144, respectively. gNB-CU-CP 142 is a logical node hosting the RRC and the control plane part of the PDCP protocol of the gNB-CU 140 for gNB 100. A gNB-CU-UP 144 is a logical node hosting the user plane part of the PDCP protocol of the gNB-CU 140, and the user plane part of the PDCP protocol and the SDAP protocol of the gNB-CU 142. gNB-DU1 130, and gNB-DU1 132 are connected to gNB-CU-CP 142 via F1-C 160, and gNB-DU1 130, and gNB-DU1 132 are connected to one or more gNB-CU-UP via F1-U 162 interfaces. The split architecture enables a 5G network to utilize different distribution of protocol stacks between gNB-CU 140, and gNB-DU1 130 and gNB-DU2 132, depending on network design and availability of the Midhaul connection 156. gNB-CU-CP 142 is coupled to one or more gNB-CU-UP 144 via one or more E1 interfaces 170.

In FIG. 1, two connections are shown between gNB-CU 140 and gNB-DU1 130 and gNB-DU2 132. gNB-CU 140 is able to implement additional connections to other gNB-DUs (not shown). gNB-CU 140, in 5G, is able to implement, for example, 256 endpoints or gNB-DUs. gNB-CU 140 supports the gNB functions such as transfer of user data, mobility control, RAN sharing (MORAN), positioning, session management, etc. However, one or more functions are able to be allocated to gNB-DU1 130 and gNB-DU2 132. gNB-CU 140 controls the operation of gNB-DU1 130 and gNB-DU2 132 over the Midhaul interface 156.

Service Management and Orchestration (SMO) 180 is responsible for managing and orchestrating the services and resources within RAN 100. SMO 180 includes functions for the Operations Support System (OSS) 182 and Element Management System (EMS) 184. SMO is also capable of supporting other and Business Support Systems (BSS) 186. EMS 184 provides systems and applications for managing network elements (NE), such as Centralized Unit (CU) 140, Distributed Units (DUs) 130, 132, and Radio Units (e.g., Radio Sites) 122, 123, 125. OSS 182 provides an end-to-end view of the network and supports functions for service orchestration, inventory, topology and policy control. In one embodiment, OSS 182 provides a Crisis Simulator 188 for simulating crisis events in the network.

Although not shown in FIG. 1, those skilled in the art understand that RAN 100 also includes a Near-Real-Time RAN Intelligent Controller (Near-RT-RIC) and a Non-RT RIC that manage separate functions of the RAN. The Non-RT-RIC is deployed centrally (as part of the SMO 150), while the Near RT-RIC can be deployed centrally or on the network edge. The Near-RT-RIC is connected to O-DU, O-CU and O-eNB through an E2 interface, and to Non-RT RIC through an A1 interface. The Non-RT RIC is of the SMO 150, and is connected to O-DU, O-CU and O-eNB through an O1 interface, and to the Near-RT RIC through an A1 interface. The Non-RT RIC manages events and resources with a response time of one second or more. For example, the Non-RT RIC is able to handle RAN optimization, policy, configuration, data analytics, frequency management, network slicing, SLAs, performance diagnostics, and the like. The Near-RT RIC manages events and resources requiring a faster response of less than 1 second, e.g., down to 10 milliseconds (ms). For example, the Near-RT RIC is able to handle Radio connection management, mobility management, interference management, handovers, load balancing, QoS, QoE, M-MIMO, and the like.

Various drills have been analyzed involving directives by government entities and several different definitions of a crisis exist. In response to a crisis being detected, a trigger from the government, news organizations, Operation Support Systems (OSS) 182, etc. is received and the impact of the crisis on the network is assessed by an Operations/BCP Manager and a response team, wherein a protocol for addressing the issue is initiated. Crises are able to be classified based on the impact, the geography where the impact occurs, the time, and the impact on the network specifically for telecommunication companies. Network operators create protocols to implement based on the impact. The protocol is able to vary based on different policies associated with the type of crisis or the identified impact on the network. In response to a crisis, an Emergency Management Team (EMT) or site recovery team is dispatched to analyze and address the crisis. Cells on Light Trucks (COLTs) and Cells on Wheels (COWs) are regularly utilized by EMT as part of recovery efforts by acting as a mobile radio site.

An Operations/BCP Manager is able to use Crisis Simulator 188 to define a crisis and generate a fake alert so that the response to the crisis is able to be evaluated. The simulation of a crisis uses protocols associated with parameters determined from the assessment of the crisis. The Crisis Simulator 188 thus is able to be used to prepare a response team. For example, a crisis simulation is able to be executed by the Crisis Simulator 188 at a time that the majority of the employees are not working, e.g., Sunday afternoon.

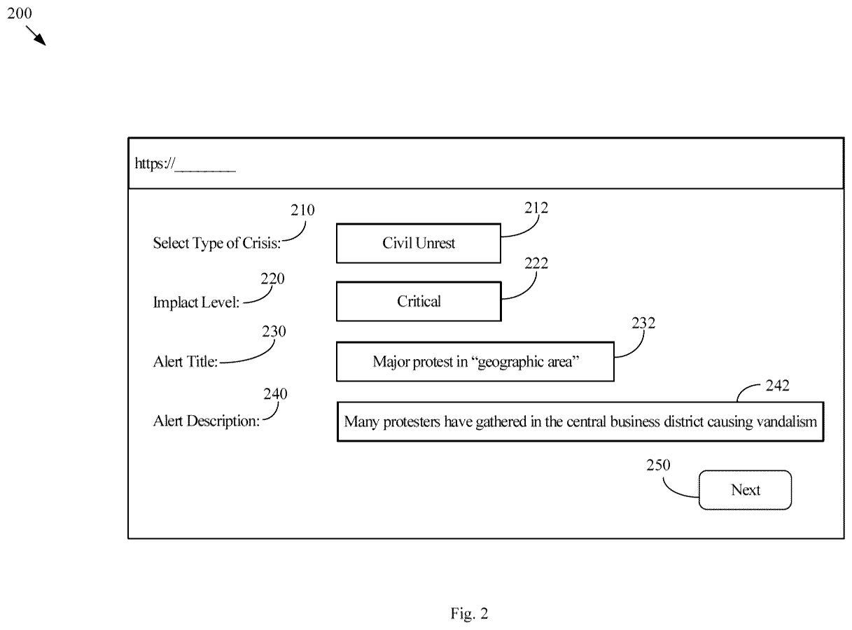

FIG. 2 is a User Interface (UI) 200 for defining a crisis according to at least one embodiment.

In FIG. 2, a drill master or user of the simulation system accesses UI 200 to define the type of crisis 210, e.g., civil unrest, natural disaster such as hurricane, typhoon, earthquake, flood, and the like. Type of Crisis 210 in FIG. 2 shows the crisis is Civil Unrest 212. An Impact Level 220 on the business is able to be selected, e.g., criticality based on the business impact. The Impact Level 220 shows the crisis has an impact level of Critical 222. The simulation is able to be given a Title 230 and a Description 240. In FIG. 2, Title 230 is Major protect in “geographic area” 232, and the Description 240 is given as “Many protesters have gathered in the central business district causing vandalism” 242. The user then selects “Next” 250.

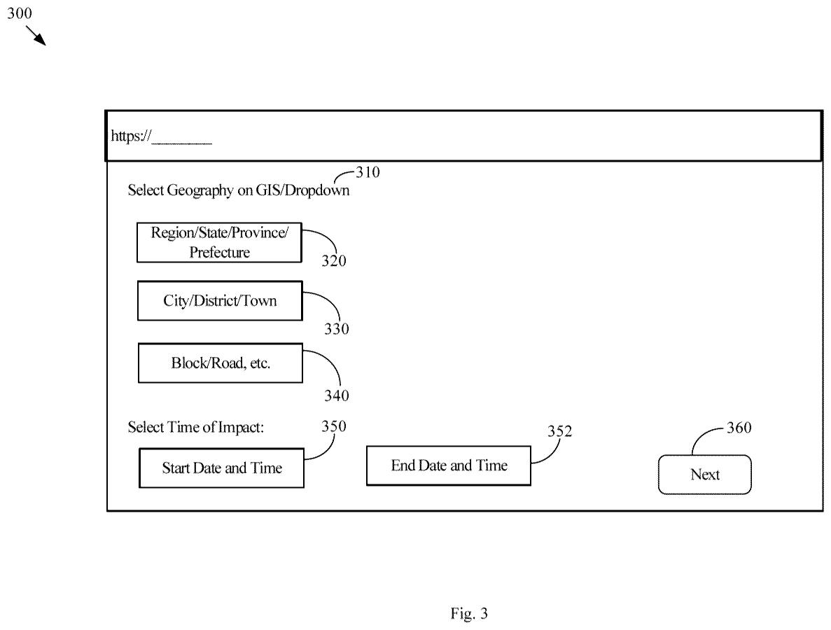

FIG. 3 is a UI 300 for selecting the geography and time of the crisis according to at least one embodiment.

In FIG. 3, the UI has a window for Selecting Geography 310, wherein the geography defines the an area in which the impact is to be tested. In FIG. 3, a window is provided to select the Region/state/Province/Prefecture 320. A City/District/Town 330 and Block/Road 340 is then identified to provide more detailed geographic selection for the crisis simulation. The user is also able to select the time of the impact of the crisis, e.g., the “Start Date and Time” 350, and the “End Date and Time” 352. The user then selects “Next” 360 to move to the next UI.

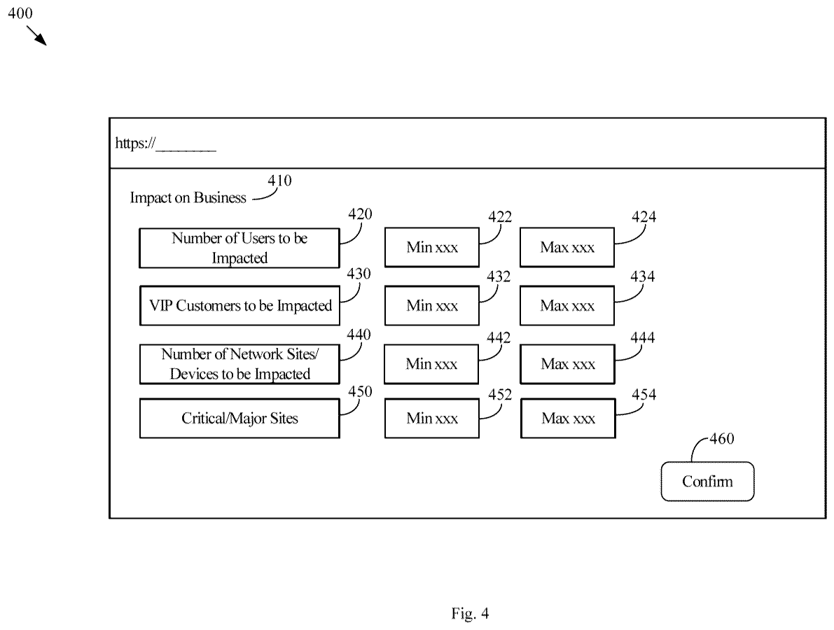

FIG. 4 is a UI 400 for selecting the impact on business for the crisis simulation according to at least one embodiment.

In FIG. 4, a window is presented for the user to define the Impact on Business 410. A first window is provided to select the “Number of Users to be Impacted” 420. The “Number of Users to be Impacted” 420 is able to range from a “Minimum” 422 to a “Maximum” 424 number of users to be impacted.

A second window is provided to select the number “VIP Customers to be Impacted” 430, which also ranges from a “Minimum” 432 to a “Maximum” 434. A third window is provided for selecting the “Number of Network Sites/Devices to be Impacted” 440, which is able to range from a “Minimum” 442 to a “Maximum” 444. The UI 400 also includes a window for selecting the number of “Critical/Major Network Sites” 450. A “Minimum” 452 and “Maximum” 454 number of “Critical/Major Network Sites” 450 to be impacted is able to be selected. For example, in response to selecting a Minimum 422 of the Number Of Users Impacted 420 of 2 and a Maximum 424 of the of the Number Of Users Impacted 420 of 10, the system is able to create combinations of the Number Of Users Impacted 420 between 2 and 10. The user then selects “Confirm” 460 to create an alert based on the selection.

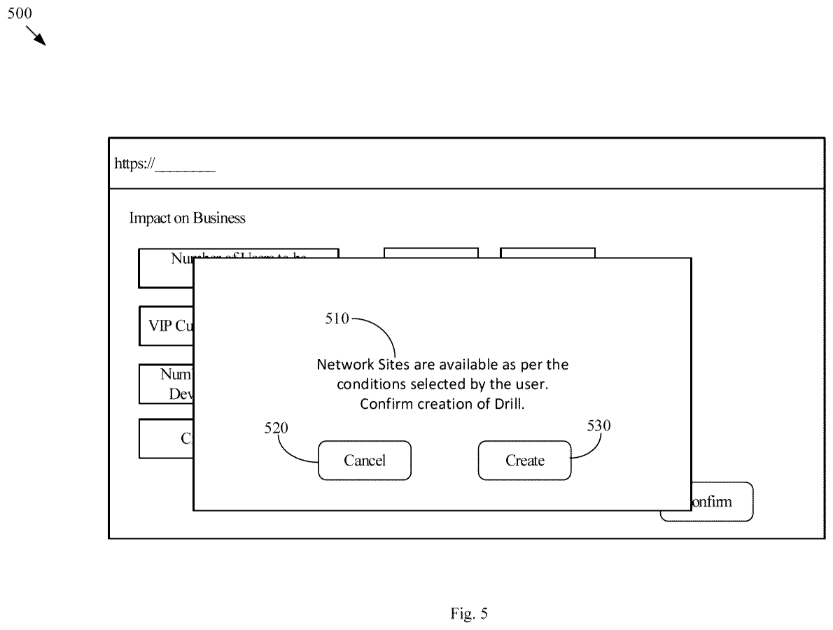

FIG. 5 is a Confirmation UI 500 according to at least one embodiment.

In FIG. 5, Confirmation UI 500 shows a message indicating “Network Sites are available as per the conditions selected by the user” 510. The user is able to select “Cancel” 520 to cancel the creation of the crisis simulation or to select “Create” 530 to create the crisis simulation.

The crisis simulation that is created uses parameters that are not real, but that are based on real network data, e.g., identification of Site Names. The crisis simulation thus is able to be used to prepare a response team. For example, the crisis simulation is able to be executed at a time that the majority of the employees are not working, e.g., Sunday afternoon. Based on the data that was selected in FIGS. 2-5, a fake alert is generated, wherein the fake alert has the same appearance as a real alert. The team is able to react to the crisis simulation based on the protocol that has been defined.

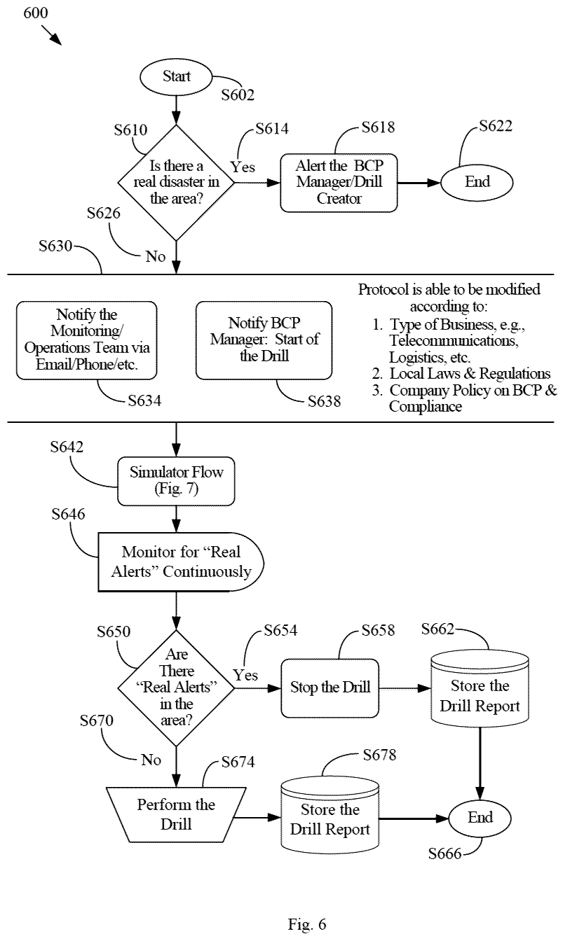

FIG. 6 is a flowchart 600 of a method for automatic simulating a crisis for Business Continuity Planning (BCP) according to at least one embodiment.

In FIG. 6, a system monitors the network to determine occurrence of a crisis. A determination is made whether there is a real crisis in the area being monitored S610. A crisis alert/notification is able to be displayed on a display running the crisis simulator on the OSS. The BCP Manager/Drill Creator is able to use the OSS to verify whether the crisis alert is real or whether the crisis alert is fake.

In response to there being a real crisis in the area S614, the BCP Manager/Drill Creator is alerted S618 to the crisis being real and the crisis simulation ends S622. Thus, the real crisis is able to be addressed instead of the crisis simulation being continued.

In response to the system determining that the crisis alert is associated with a simulated crisis (e.g., fake crisis) S626, notifications are sent to the appropriate parties S630. A notification is sent to the Monitoring/Operations Team S634, for example, by email, phone, etc. A notification is also sent to the BCP Manager S638 to indicate the start of the drill based on the crisis simulation. The protocol to be implemented in response to the crisis simulation is able to be modified according to a Type of Business, e.g., Telecommunications, Logistics, etc., Local Laws and Regulations, Company Policy on BCP and Compliance, and the like.

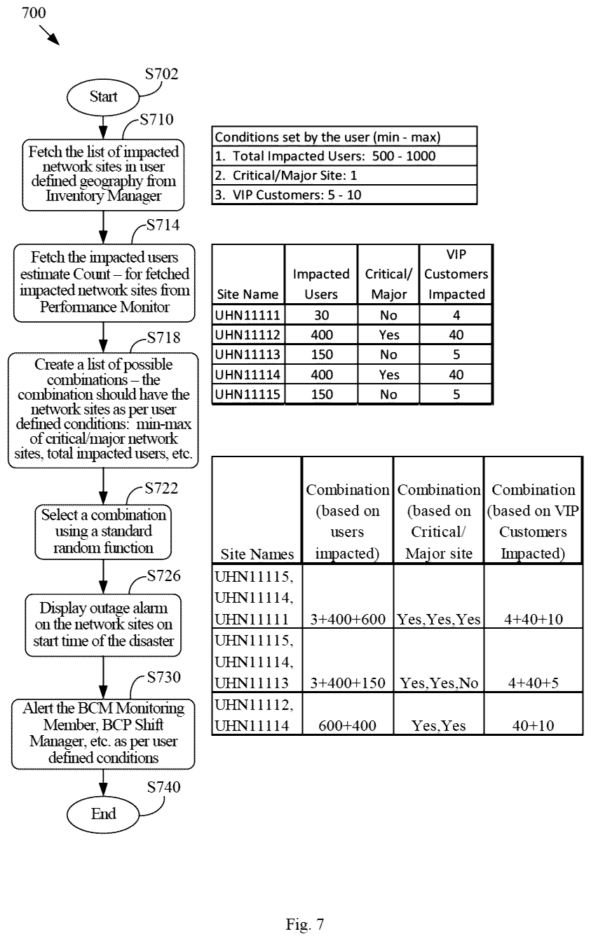

Next, the Simulation Flow is initiated S642. Details of the Simulation Flow are shown in FIG. 7.

The system continues to monitor for “Real Alerts” S646. Again, a real crisis takes precedence over a simulated crisis.

A determination is made whether there are “Real Alerts” in the area S650. In response to there being “Real Alerts” in the area S654, the drill is terminated S658. A Drill Report is stored S662. A Drill Report includes at least one of a start time and an end time of the crisis simulation, a response time of a team responding to the crisis simulation, a time identifying a time for the team to complete analysis of the network sites impacted by the crisis simulation, a response time of completing a report by the team, or a dispatch time identifying how quickly the team was dispatched to address the crisis simulation. The process then terminates S666.

In response to no “Real Alerts” being detected in the area S670, the drill is performed S674. As described above, the drill is based on a protocol, which is based on a Type of Business, e.g., Telecommunications, Logistics, etc., Local Laws and Regulations, Company Policy on BCP and Compliance, and the like.

After completion of the drill based on the crisis simulation, a Drill Report is stored S678. As described above, the Drill Report is generated in response to a “Real” crisis being detected and the simulation being terminated, or after completion of the Crisis Simulation. Drill Report includes the time, the response time of the team (e.g., how fast did the team respond to the crisis simulation alert, how quickly the team checked the sites, how quickly did the team report, how quickly the recovery team was dispatched), and the like. The drill report enables the response of the operations and monitoring teams to be analyzed to identify areas for improvement.

The process then terminates S666.

FIG. 7 is a flow chart of the Simulation Flow 700 according to at least one embodiment.

In FIG. 7, the Simulation Flow begins S702, and the list of impacted network sites in a defined geography are fetched from Inventory Manager S710. Data is entered into a crisis simulation User Interface (UI) to define a crisis. Data is entered into a crisis simulation definition UI to define a type of crisis and an impact of the crisis. A title and description is also able to be entered. Data entered in a geography UI to define geographic constraints of the crisis simulation. Data is entered in a business impact UI to identify a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation. The list of impacted network sites is based on the data entered in the crisis simulation definition UI, the data entered in the geography UI, and the data entered in the business impact UI.

An impacted users estimate count for the list of impacted network sites is fetched S714. The impacted users estimate count is fetched for network sites from Performance Monitor. The user estimate count is based on the conditions set by the user as shown in FIGS. 2-4. The Site Names and Impacted Users, VIP Customers, whether Critical/Major are based on actual data pulled from the network. However, the actual alarm or notification for the crisis simulation is fake. In FIG. 7, an example of conditions set by the user include a Total Impacted Users: 500-1000, Critical/Major Site: 1, and VIP Customers: 5-10.

A list of combinations of network sites, impacted users, identification of whether the crisis simulation impacts critical or major network sites, and a number of VIP customers impacted by the crisis simulation is created based on a random function S718. The system randomly generates a combination, or alternatively, the user is able to choose from a list of combinations as shown in FIG. 7. The combination includes the network sites as per user defined conditions: min-max of critical/major network sites, total impacted users, etc. In FIG. 7, an example is shown that includes Site Names of UHN11111, UHN11112, and UHN11113. For UHN11111, the number Impacted Users is 30, an indication that Critical/Major is No, and the number of VIP Customers Impacted is 4. For UHN11112, the number Impacted Users is 400, an indication that Critical/Major is Yes, and the number of VIP Customers Impacted is 40. For UHN11113, the number Impacted Users is 150, an indication that Critical/Major is No, and the number of VIP Customers Impacted is 5. For UHN11114, the number Impacted Users is 400, an indication that Critical/Major is Yes, and the number of VIP Customers Impacted is 40. For UHN11115, the number Impacted Users is 150, an indication that Critical/Major is No, and the number of VIP Customers Impacted is 5.

At least one of the combinations is selected S722. The one of the combinations that is selected is an automated random selection of one of the combinations or a selection of the one of the combinations is selected by the manager of the mobile network. FIG. 7 shows three combinations that are selected by the random function. A first combination includes Site Names UHN11115, UHN11114, and UHN11111, a combination of the Impacted Users is 3+400+600, the combination of Critical/Major Network Sites is Yes, Yes, Yes, and a combination based on VIP Customers Impacted is 4+40+10. A second combination includes Site Names UHN11115, UHN11114, and UHN11113, a combination of the Impacted Users is 3+400+150, the combination of Critical/Major Network Sites is Yes, Yes, No, and a combination based on VIP Customers Impacted is 4+40+5. A third combination includes Site Names UHN11112, and UHN11114, a combination of the Impacted Users is 600+400, the combination of Critical/Major Network Sites is Yes, Yes, and a combination based on VIP Customers Impacted is 40+10.

After a combination has been selected, an outage alarm based on the selected one of the combinations is displayed on the network sites at the start time of the crisis simulation S726.

The BCM Monitoring Member, BCP Shift Manager, etc. are alerted as per user defined conditions S730, e.g., an alarm is generated. For example, the number of network sites that are down or that have a power outage is shown to the recovery team.

The Simulation Flow ends S740 and the process continues at Monitor for “Real Alerts” S650 as shown in FIG. 4.

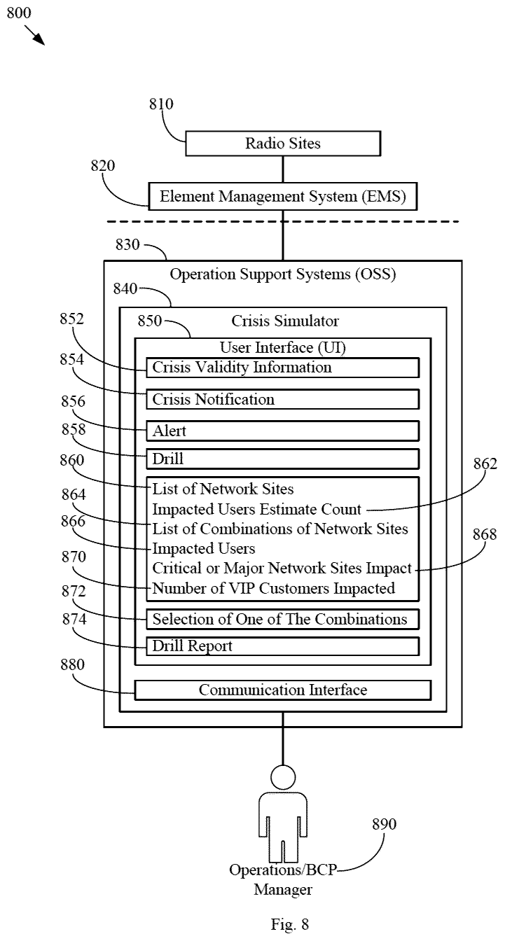

FIG. 8 shows a block diagram of the crisis simulator 800 according to at least one embodiment.

In FIG. 8, Radio Sites Layer 810 represents the live radio sites in the network. A second layer is the Element Management System (EMS) 820. A third layer is the Operations Support System (OSS) 830, which is abstracted from the actual network and presents the Crisis Simulator 840.

The Operations/BCP Manager 890 accesses the Crisis Simulator 840 through the OSS system 830. The Operations/BCP Manager 890 has control over how to manipulate data on the OSS system 830. However, the Operations/BCP Manager 890 does not have control over the EMS system 820 from the Crisis Simulator 840 of OSS system 830.

The Operations/BCP Manager 890 has flexibility to check the EMS system 820 directly, e.g., in case confirmation of a crisis notification is desired. However, operations for simulating a crisis are directly handled by the Operations/BCP Manager 890 through the Crisis Simulator 840 of OSS system 830.

The Crisis Simulator 840 of OSS system 830 receives an alert regarding a crisis. The Operations/BCP Manager 890 checks the OSS system 830 to determine whether the alert is a fake alert (e.g., generated by the Crisis Simulator 840).

Through control over the OSS system 830, a fake alert is able to be presented and the Operations/BCP Manager 890 is able to determine whether the alert is a fake alert. In response to the alert, the Operations/BCP Manager 890 initiates a drill by a response team to address the simulated crisis associated with the fake alert. Thus, an Operations/BCP Manager 890 also has the flexibility to check directly in the EMS system 820 to verify the crisis is a simulated crisis and that the alert is therefore a fake alert.

The Crisis Simulator 840 includes a User Interface (UI) 850 for presenting a Crisis Notification 854 associated with a mobile network. The Crisis Simulator 840 also includes a Communications Interface 880 for accessing network information to determine whether the Crisis Notification 854 is a fake crisis notification associated with a crisis simulation. The UI 850 receives Crisis Validity Information 852 based on the network information accessed via the Communication Interface 880 indicating whether the Crisis Notification 854 is a fake crisis notification associated with the crisis simulation. In response to the receiving the Crisis Validity Information 852 indicating the Crisis Notification 854 is a real crisis notification, an Alert 856 is provided to a manager of the mobile network indicated that the Crisis Notification 854 is associated with a real crisis and presenting a crisis response for addressing the real crisis; or un response to the receiving the Crisis Validity Information 852 indicating the Crisis Notification 854 is associated with the crisis simulation, an Alert 856 is provided to the manager of the mobile network that the Crisis Notification 854 is associated with the crisis simulation and to initiate a Drill 858 according to a predetermined protocol to address the crisis simulation. The predetermined protocol to address the crisis simulation is based on one or more of a type of business, local laws and regulations, and company policy on BCP and compliance. Data defining the crisis simulation is received via the UI 850 including one or more of a type of crisis and an impact of the crisis, geographic constraints of the crisis simulation, a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation. The Crisis Notification 854 associated with the mobile network is based on a List Of Network Sites in a defined geography received from an Inventory Manager, an Impacted Users Estimate Count for the list of the network sites obtained from a Performance Monitor, a List of Combinations of The Network Sites, Impacted Users, Critical Or Major Network Sites Impact, and a Number Of VIP Customers Impacted by the crisis simulation. A Selection Of One Of The Combinations is received via the UI 850, wherein the Crisis Notification 854 is based on the Selection Of The One Of The Combinations. The Selection Of The One Of The Combinations is based on an automated random selection of the one of the combinations or a manual selection of the one of the combinations provided via the UI 850 by the manager of the mobile network. The Crisis Notification 854 is based on continuous monitoring of the mobile network for the notification of the real crisis after the Drill 858 is initiated. In response to receiving the Crisis Notification 854 of the real crisis after initiating the Drill 858, the Drill 858 is stopped and a Drill Report 874 is saved, or in response to not receiving the Crisis Notification 854 of the real crisis after initiating the Drill 858, the Drill 858 is completed and the Drill Report 874 is saved. The Drill Report 874 includes at least one of a start time and an end time of the crisis simulation, a response time of a team responding to the crisis simulation, a completion time of the team completing analysis of network sites impacted by the crisis simulation, a response time of completing a report by the team, or a dispatch time identifying how quickly the team was dispatched to address the crisis simulation.

At least one embodiment of the method for providing automated crisis simulation for Business Continuity Planning (BCP) includes entering data in a crisis simulation User Interface (UI) to define a crisis simulation, receiving a notification of a crisis associated with a mobile network, determining whether the notification of the crisis is a fake crisis notification associated with the crisis simulation, and in response to the notification being determined to be a real crisis notification, notifying a manager of the mobile network of a real crisis and ending the crisis simulation, or in response to the notification being determined to be the fake crisis notification associated with the crisis simulation, notifying the manager of the mobile network to initiate a drill according to a predetermined protocol to address the crisis simulation, and initiating the drill according to the predetermined protocol to address the crisis simulation.

User Interfaces are provided for selecting parameters for defining a crisis simulation. In a first UI, a Type of Crisis, an Impact Level of the crisis, a Title and a Description are selected. In a Geography UI, a Region/State/Province/Prefecture, City/District/Town, and Block/Road etc. are selected. A Start & Ending Time of the Impact is selected. In Business Impact UI, a Number of Users, a Number of VIP Customers, a Number of Network Sites/Devices, and a Number of Critical/Major Network Sites are selected. Alarms/Notifications are sent to the monitoring operations team and BCP manager. The Alarms/Notifications are checked to determine whether the Alarms/Notifications are associated with a real crisis or a fake/simulated crisis. For example, an indication is provided to indicate whether the Alarms/Notifications are associated with a real crisis or a fake/simulated crisis. Identification of Impacted Network Sites for the Simulation is provided. The Identification of Impacted Network Sites for the Simulation includes a number of Impacted Users, an indication of the criticality of the simulated crisis (Critical/Major), and a number of VIP Customers Impacted. Random Combinations (Site Names, Number of Users Impacted, Critical/Major, and VIP Customers Impacted) are identified and displayed. A Selected Combination (Random Selection or by User) is made. A Protocol is used to address the simulated crisis, wherein the Protocol is based on a Type of Business, Local Laws & Regulations, Company Policy on BCP & Compliance, and the like. A Drill Report is generated in response to a “Real” crisis being detected and the simulation being terminated, or after completion of the Crisis Simulation. Drill Report includes the time, the response time of the team (e.g., how fast did the team respond to the crisis simulation alert, how quickly the team checked the network sites, how quickly did the team report, how quickly the recovery team was dispatched), and the like. The crisis simulator creates an automated crisis simulation and initiation of aversion drills to test and improve preparedness of response teams for handling a crisis.

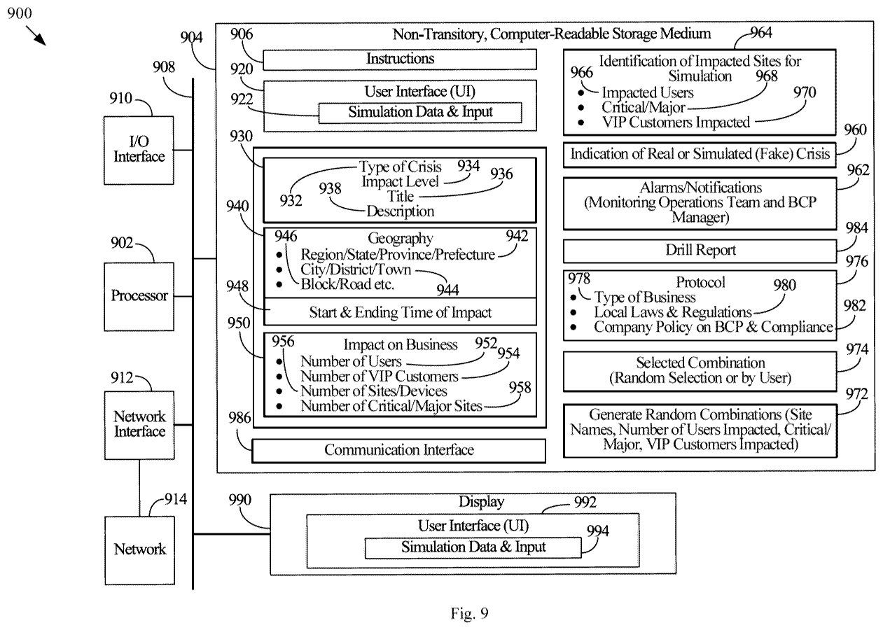

FIG. 9 is a high-level functional block diagram of a processor-based system 900 according to at least one embodiment.

In at least one embodiment, processing circuitry 900 provides an automated crisis simulator for Business Continuity Planning (BCP). Processing circuitry 900 implements the automated crisis simulator for Business Continuity Planning (BCP) using Processor 902. Processing circuitry 900 also includes a Non-Transitory, Computer-Readable Storage Medium 904 that is used to implement the automated crisis simulator for Business Continuity Planning (BCP). Non-Transitory, Computer-Readable Storage Medium 904, amongst other things, is encoded with, i.e., stores, Instructions 906, i.e., computer program code, that are executed by Processor 902 causes Processor 902 to perform operations for providing automated crisis simulation for Business Continuity Planning (BCP). Execution of Instructions 906 by Processor 902 represents (at least in part) an application which implements at least a portion of the methods described herein in accordance with one or more embodiments (hereinafter, the noted processes and/or methods).

Processor 902 is electrically coupled to Non-Transitory, Computer-Readable Storage Medium 904 via a Bus 908. Processor 902 is electrically coupled to an Input/Output (I/O) Interface 910 by Bus 908. A Network Interface 912 is also electrically connected to Processor 902 via Bus 908. Network Interface 912 is connected to a Network 914, so that Processor 902 and Non-Transitory, Computer-Readable Storage Medium 904 connect to external elements via Network 914. Processor 902 is configured to execute Instructions 906 encoded in Non-Transitory, Computer-Readable Storage Medium 904 to cause processing circuitry 900 to be usable for performing at least a portion of the processes and/or methods. In one or more embodiments, Processor 902 is a Central Processing Unit (CPU), a multi-processor, a distributed processing system, an Application Specific Integrated Circuit (ASIC), and/or a suitable processing unit.

Processing circuitry 900 includes I/O Interface 910. I/O interface 910 is coupled to external circuitry. In one or more embodiments, I/O Interface 910 includes a keyboard, keypad, mouse, trackball, trackpad, touchscreen, and/or cursor direction keys for communicating information and commands to Processor 902.

Processing circuitry 900 also includes Network Interface 912 coupled to Processor 902. Network Interface 912 allows processing circuitry 900 to communicate with Network 914, to which one or more other computer systems are connected. Network Interface 912 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 900 is configured to receive information through I/O Interface 910. The information received through I/O Interface 910 includes one or more of instructions, data, design rules, libraries of cells, and/or other parameters for processing by Processor 902. The information is transferred to Processor 902 via Bus 908. Processing circuitry 900 is configured to receive information related to a User Interface (UI) 920 through I/O Interface 910. The information is stored in Non-Transitory, Computer-Readable Storage Medium 904 as UI 920, wherein UI 920 presents simulation data and enables data input for defining the crisis simulation 922.

In one or more embodiments, one or more Non-Transitory, Computer-Readable Storage Medium 904 having stored thereon Instructions 906 (in compressed or uncompressed form) that may be used to program a computer, processor, or other electronic device) to perform processes or methods described herein. The one or more Non-Transitory, Computer-Readable Storage Medium 904 include one or more of an electronic storage medium, a magnetic storage medium, an optical storage medium, a quantum storage medium, or the like.

For example, the Non-Transitory, Computer-Readable Storage Medium 904 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 904 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 904 stores Instructions 906 configured to cause Processor 902 to perform at least a portion of the processes and/or methods for the automated crisis simulation for Business Continuity Planning (BCP). In one or more embodiments, Non-Transitory, Computer-Readable Storage Medium 904 also stores information, such as algorithm which facilitates performing at least a portion of the processes and/or methods for the automated crisis simulation for Business Continuity Planning (BCP).

Accordingly, in at least one embodiment, Processor 902 executes Instructions 906 stored on the one or more Non-Transitory, Computer-Readable Storage Medium 904 to implement User Interfaces 930, 940, 950 for selecting parameters for defining a crisis simulation. In a first UI 930, a Type of Crisis 932, an Impact Level 934 of the crisis, a Title 936 and a Description 938 are selected. In Geography UI 940, a Region/State/Province/Prefecture 942, City/District/Town 944, and Block/Road etc. 946 are selected. A Start & Ending Time of the Impact 948 is selected. In Impact on Business UI 950, a Number of Users 952, a Number of VIP Customers 954, a Number of Sites/Devices 956, and a Number of Critical/Major Sites 958 are selected. Processor 902 provides an Indication of Real or Simulated (Fake) Crisis 960. Processor 902 also generates Alarms/Notifications 962 that are sent to the monitoring operations team and BCP manager. Identification of Impacted Sites for the Simulation 964 is provided. The Identification of Impacted Sites for the Simulation 964 includes a number of Impacted Users 966, an indication of the criticality of the simulated crisis (Critical/Major) 968, and a number of VIP Customers Impacted 970. Processor 902 generates Random Combinations (e.g., Site Names, Number of Users Impacted, Critical/Major, and VIP Customers Impacted) 972. A Selected Combination (Random Selection or by User) 974 is made. Protocol 976 is used to address the simulated crisis, wherein Protocol 976 is based on a Type of Business 978, Local Laws & Regulations 980, Company Policy on BCP & Compliance 982, and the like. Processor 902 generates a Drill Report 984. Drill Report 984 is generated in response to a “Real” crisis being detected and the simulation being terminated, or after completion of the Crisis Simulation. Drill Report 984 includes the time, the response time of the team (e.g., how fast did the team respond to the crisis simulation alert, how quickly the team checked the sites, how quickly did the team report, how quickly the recovery team was dispatched), and the like. A Communications Interface 986 is used to access accessing network information to determine whether the crisis notification is a fake crisis notification associated with a crisis simulation. Processor 902 uses Display 990 to present a User Interface (UI) 992. UI 992 enables a user to select and view Simulation Data 994.

Embodiments described herein provide a method that provides one or more advantages. For example, to improve the preparedness of operations and monitoring teams, a simulated crisis in a mobile network is defined and initiated. The simulated crisis imitates the external risks to the mobile network, including (but not limited to) natural disasters, civil unrests or external threats can have a huge impact on the business. Drills are able to be regularly performed to determine the preparedness of the operations and monitoring teams, wherein the drills are based on a set of protocols specified by factors such as a Type of Business, Local Laws & Regulations, Company Policy on BCP & Compliance, and the like. A drill report is recorded, which enables the response of the operations and monitoring teams to be analyzed to identify areas for improvement.

An aspect of this description is directed to a method [1] for providing automated crisis simulation for Business Continuity Planning (BCP) includes entering data in a crisis simulation User Interface (UI) to define a crisis simulation, receiving a notification of a crisis associated with a mobile network, determining whether the notification of the crisis is a fake crisis notification associated with the crisis simulation, and in response to the notification being determined to be a real crisis notification, notifying a manager of the mobile network of the real crisis and ending the crisis simulation, or in response to the notification being determined to be the fake crisis notification associated with the crisis simulation, notifying the manager of the mobile network to initiate a drill according to a predetermined protocol to address the crisis simulation, and initiating the drill according to the predetermined protocol to address the crisis simulation.

The method described in [1], wherein the initiating the drill according to the predetermined protocol to address the crisis simulation includes initiating the drill according to the predetermined protocol that is based on a type of Business, local laws and regulations, and company policy on BCP and compliance.

The method described in any one of [1] or [2], wherein the entering the data in the crisis simulation UI to define the crisis simulation includes at least one of entering data in a crisis simulation definition UI to define a type of crisis and an impact of the crisis, entering data in a geography UI to define geographic constraints of the crisis simulation, and entering data in a business impact UI to identify a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation.

The method described in any one of [1] to [3], wherein the receiving the notification of the crisis associated with the mobile network includes fetching a list of network sites in a defined geography from an Inventory Manager, fetching from a Performance Monitor an impacted users estimate count for the list of the network sites, creating a list of combinations of the network sites, impacted users, identification of whether the crisis simulation impacts critical or major network sites, and a number of VIP customers impacted by the crisis simulation.

The method described in any one of [1] to [4] further including selecting one of the combinations and generating the notification of the crisis simulation using the one of the combinations selected, wherein the selecting one of the combinations is an automated random selection of the one of the combinations or a selection of the one of the combinations selected by the manager of the mobile network.

The method described in any one of [1] to [5] further includes continuing to monitor the mobile network for a notification of the real crisis after the initiating the drill.

The method described in any one of [1] to [6] further including in response to receiving the notification of the real crisis after initiating the drill, stopping the drill and saving a drill report, or in response to not receiving the notification of the real crisis after initiating the drill, completing the drill and saving the drill report, wherein the drill report includes at least one of a start time and an end time of the crisis simulation, a response time of a team responding to the crisis simulation, a completion time of the team completing analysis of network sites impacted by the crisis simulation, a response time of completing a report by the team, or a dispatch time identifying how quickly the team was dispatched to address the crisis simulation.

An aspect of this description is directed to a crisis simulator [8] includes a user interface (UI) for presenting a crisis notification associated with a mobile network, a communications interface for accessing network information to determine whether the crisis notification is a fake crisis notification associated with a crisis simulation, wherein the UI receives crisis validity information based on the network information accessed via the communication interface indicating whether the crisis notification is a fake crisis notification associated with the crisis simulation, and in response to the receiving the crisis validity information indicating the crisis notification is a real crisis notification, providing an alert to a manager of the mobile network that the crisis notification is associated with a real crisis and presenting a crisis response for addressing the real crisis, or in response to the receiving the crisis validity information indicating the crisis notification is associated with the crisis simulation, providing an alert to the manager of the mobile network that the crisis notification is associated with the crisis simulation and to initiate a drill according to a predetermined protocol to address the crisis simulation.

The crisis simulator described in [8], wherein the predetermined protocol to address the crisis simulation is based on one or more of a type of business, local laws and regulations, and company policy on BCP and compliance.

The crisis simulator described in any one of [8] or [9] further includes the UI being configured to receive data defining the crisis simulation including one or more of a type of crisis and an impact of the crisis, geographic constraints of the crisis simulation, a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation.

The crisis simulator described in any one of [8] to [10], wherein the crisis notification associated with the mobile network is based on a list of network sites in a defined geography received from an Inventory Manager, an impacted users estimate count for the list of the network sites obtained from a Performance Monitor, a list of combinations of the network sites, impacted users, identification of whether the crisis simulation impacts critical or major network sites, and a number of VIP customers impacted by the crisis simulation.

The crisis simulator described in any one of [8] to [11], wherein the UI receives a selection of one of the combinations, wherein the crisis notification is based on the selection of the one of the combinations, and wherein the selection of the one of the combinations is based on an automated random selection of the one of the combinations or a manual selection of the one of the combinations provided via the UI by the manager of the mobile network.

The crisis simulator described in any one of [8] to [12], wherein the crisis notification is based on continuous monitoring of the mobile network for the notification of the real crisis after the drill is initiated.

The crisis simulator described in any one of [8] to [13], wherein in response to receiving the crisis notification of the real crisis after initiating the drill, the drill is stopped and a drill report is saved, or in response to not receiving the notification of the real crisis after initiating the drill, the drill is completed and the drill report is saved, wherein the drill report includes at least one of a start time and an end time of the crisis simulation, a response time of a team responding to the crisis simulation, a completion time of the team completing analysis of network sites impacted by the crisis simulation, a response time of completing a report by the team, or a dispatch time identifying how quickly the team was dispatched to address the crisis simulation.

An aspect of this description is directed to a non-transitory computer-readable media having computer-readable instructions stored thereon [15], which when executed by a processor causes the processor to perform operations including entering data in a crisis simulation User Interface (UI) to define a crisis simulation, receiving a notification of a crisis associated with a mobile network, determining whether the notification of the crisis is a fake crisis notification associated with the crisis simulation, and in response to the notification being determined to be a real crisis notification, notifying a manager of the mobile network of a real crisis and ending the crisis simulation, or in response to the notification being determined to be the fake crisis notification associated with the crisis simulation, notifying the manager of the mobile network to initiate a drill according to a predetermined protocol to address the crisis simulation, and initiating the drill according to the predetermined protocol to address the crisis simulation.

The non-transitory computer-readable media described in [15], wherein the initiating the drill according to the predetermined protocol to address the crisis simulation includes initiating the drill according to the predetermined protocol that is based on a type of Business, local laws and regulations, and company policy on BCP and compliance.

The non-transitory computer-readable media described in any one of or [16], wherein the entering the data in the crisis simulation UI to define the crisis simulation includes at least one of entering data in a crisis simulation definition UI to define a type of crisis and an impact of the crisis, entering data in a geography UI to define geographic constraints of the crisis simulation, and entering data in a business impact UI to identify a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation.

The non-transitory computer-readable media described in any one of to [17], wherein the receiving the notification of the crisis associated with the mobile network includes fetching a list of network sites in a defined geography from an Inventory Manager, fetching from a Performance Monitor an impacted users estimate count for the list of the network sites, creating a list of combinations of the network sites, impacted users, identification of whether the crisis simulation impacts critical or major network sites, and a number of VIP customers impacted by the crisis simulation.

The non-transitory computer-readable media described in any one of to further including selecting one of the combinations and generating the notification of the crisis simulation using the one of the combinations selected, wherein the selecting one of the combinations is an automated random selection of the one of the combinations or a selection of the one of the combinations selected by the manager of the mobile network.

The non-transitory computer-readable media described in any one of to further including continuing to monitor the mobile network for a notification of the real crisis after the initiating the drill, and in response to receiving the notification of the real crisis after initiating the drill, stopping the drill and saving a drill report, or in response to not receiving the notification of the real crisis after initiating the drill, completing the drill and saving the drill report, wherein the drill report includes at least one of a start time and an end time of the crisis simulation, a response time of a team responding to the crisis simulation, a completion time of the team completing analysis of network sites impacted by the crisis simulation, a response time of completing a report by the team, or a dispatch time identifying how quickly the team was dispatched to address the crisis simulation.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for providing automated crisis simulation for Business Continuity Planning (BCP), comprising:
entering data in a crisis simulation User Interface (UI) to define a crisis simulation;
receiving a notification of a crisis associated with a mobile network;
determining whether the notification of the crisis is a fake crisis notification associated with the crisis simulation; and
in response to the notification being determined to be a real crisis notification, notifying a manager of the mobile network of a real crisis and ending the crisis simulation; or
in response to the notification being determined to be the fake crisis notification associated with the crisis simulation, notifying the manager of the mobile network to initiate a drill according to a predetermined protocol to address the crisis simulation, and initiating the drill according to the predetermined protocol to address the crisis simulation.

2. The method of claim 1, wherein the initiating the drill according to the predetermined protocol to address the crisis simulation includes initiating the drill according to the predetermined protocol that is based on a type of Business, local laws and regulations, and company policy on BCP and compliance.

3. The method of claim 1, wherein the entering the data in the crisis simulation UI to define the crisis simulation includes at least one of entering data in a crisis simulation definition UI to define a type of crisis and an impact of the crisis, entering data in a geography UI to define geographic constraints of the crisis simulation, and entering data in a business impact UI to identify a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation.

4. The method of claim 1, wherein the receiving the notification of the crisis associated with the mobile network includes fetching a list of network sites in a defined geography from an Inventory Manager, fetching from a Performance Monitor an impacted users estimate count for the list of the network sites, creating a list of combinations of the network sites, impacted users, identification of whether the crisis simulation impacts critical or major network sites, and a number of VIP customers impacted by the crisis simulation.

5. The method of claim 4 further comprising selecting one of the combinations and generating the notification of the crisis simulation using the one of the combinations selected, wherein the selecting one of the combinations is an automated random selection of the one of the combinations or a selection of the one of the combinations selected by the manager of the mobile network.

6. The method of claim 1 further comprising continuing to monitor the mobile network for the notification of the real crisis after the initiating the drill.

7. The method of claim 6 further comprises:
in response to receiving the notification of the real crisis after initiating the drill, stopping the drill and saving a drill report; or
in response to not receiving the notification of the real crisis after initiating the drill, completing the drill and saving the drill report;
wherein the drill report includes at least one of a start time and an end time of the crisis simulation, a response time of a team responding to the crisis simulation, a completion time of the team completing analysis of network sites impacted by the crisis simulation, a response time of completing a report by the team, or a dispatch time identifying how quickly the team was dispatched to address the crisis simulation.

8. A crisis simulator, comprising:
a user interface (UI) for presenting a crisis notification associated with a mobile network;
a communications interface for accessing network information to determine whether the crisis notification is a fake crisis notification associated with a crisis simulation;
wherein the UI receives crisis validity information based on the network information accessed via the communication interface indicating whether the crisis notification is a fake crisis notification associated with the crisis simulation; and
in response to the receiving the crisis validity information indicating the crisis notification is a real crisis notification, providing an alert to a manager of the mobile network that the crisis notification is associated with a real crisis and presenting a crisis response for addressing the real crisis; or
in response to the receiving the crisis validity information indicating the crisis notification is associated with the crisis simulation, providing an alert to the manager of the mobile network that the crisis notification is associated with the crisis simulation and to initiate a drill according to a predetermined protocol to address the crisis simulation.

9. The crisis simulator of claim 8, wherein the predetermined protocol to address the crisis simulation is based on one or more of a type of business, local laws and regulations, and company policy on BCP and compliance.

10. The crisis simulator of claim 8 further includes the UI being configured to receive data defining the crisis simulation including one or more of a type of crisis and an impact of the crisis, geographic constraints of the crisis simulation, a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation.

11. The crisis simulator of claim 8, wherein the crisis notification associated with the mobile network is based on a list of network sites in a defined geography received from an Inventory Manager, an impacted users estimate count for the list of the network sites obtained from a Performance Monitor, a list of combinations of the network sites, impacted users, identification of whether the crisis simulation impacts critical or major network sites, and a number of VIP customers impacted by the crisis simulation.

12. The crisis simulator of claim 11, wherein the UI receives a selection of one of the combinations, wherein the crisis notification is based on the selection of the one of the combinations, and wherein the selection of the one of the combinations is based on an automated random selection of the one of the combinations or a manual selection of the one of the combinations provided via the UI by the manager of the mobile network.

13. The crisis simulator of claim 8, wherein the crisis notification is based on continuous monitoring of the mobile network for the notification of the real crisis after the drill is initiated.

14. The crisis simulator of claim 13, wherein:
in response to receiving the crisis notification of the real crisis after initiating the drill, the drill is stopped and a drill report is saved; or
in response to not receiving the notification of the real crisis after initiating the drill, the drill is completed and the drill report is saved;
wherein the drill report includes at least one of a start time and an end time of the crisis simulation, a response time of a team responding to the crisis simulation, a completion time of the team completing analysis of network sites impacted by the crisis simulation, a response time of completing a report by the team, or a dispatch time identifying how quickly the team was dispatched to address the crisis simulation.

15. A non-transitory computer-readable media having computer-readable instructions stored thereon, which when executed by a processor causes the processor to perform operations comprising:
entering data in a crisis simulation User Interface (UI) to define a crisis simulation;
receiving a notification of a crisis associated with a mobile network;
determining whether the notification of the crisis is a fake crisis notification associated with the crisis simulation; and
in response to the notification being determined to be a real crisis notification, notifying a manager of the mobile network of a real crisis and ending the crisis simulation; or
in response to the notification being determined to be the fake crisis notification associated with the crisis simulation, notifying the manager of the mobile network to initiate a drill according to a predetermined protocol to address the crisis simulation, and initiating the drill according to the predetermined protocol to address the crisis simulation.

16. The non-transitory computer-readable media of claim 15, wherein the initiating the drill according to the predetermined protocol to address the crisis simulation includes initiating the drill according to the predetermined protocol that is based on a type of Business, local laws and regulations, and company policy on BCP and compliance.

17. The non-transitory computer-readable media of claim 15, wherein the entering the data in the crisis simulation UI to define the crisis simulation includes at least one of entering data in a crisis simulation definition UI to define a type of crisis and an impact of the crisis, entering data in a geography UI to define geographic constraints of the crisis simulation, and entering data in a business impact UI to identify a minimum and maximum number of users impacted by the crisis simulation, a minimum and maximum number of VIP customers impacted by the crisis simulation, a minimum and maximum number of network sites or devices impacted by the crisis simulation, or a minimum and maximum number of critical or major network sites impacted by the crisis simulation.

18. The non-transitory computer-readable media of claim 15, wherein the receiving the notification of the crisis associated with the mobile network includes fetching a list of network sites in a defined geography from an Inventory Manager, fetching from a Performance Monitor an impacted users estimate count for the list of the network sites, creating a list of combinations of the network sites, impacted users, identification of whether the crisis simulation impacts critical or major network sites, and a number of VIP customers impacted by the crisis simulation.

19. The non-transitory computer-readable media of claim 18 further comprising selecting one of the combinations and generating the notification of the crisis simulation using the one of the combinations selected, wherein the selecting one of the combinations is an automated random selection of the one of the combinations or a selection of the one of the combinations selected by the manager of the mobile network.

20. The non-transitory computer-readable media of claim 15 further comprising:
continuing to monitor the mobile network for the notification of the real crisis after the initiating the drill; and
in response to receiving the notification of the real crisis after initiating the drill, stopping the drill and saving a drill report; or
in response to not receiving the notification of the real crisis after initiating the drill, completing the drill and saving the drill report;
wherein the drill report includes at least one of a start time and an end time of the crisis simulation, a response time of a team responding to the crisis simulation, a completion time of the team completing analysis of network sites impacted by the crisis simulation, a response time of completing a report by the team, or a dispatch time identifying how quickly the team was dispatched to address the crisis simulation.
